(19) United States
(12) Patent Application Publication
(10) Pub. No.: US 2024/0083639 A1
(43) Pub. Date: Mar. 14, 2024

(54) ONE-HANDED PRESS-OPEN COSMETIC CONTAINER

(71) Applicant: ZHEJIANG UKPACK PACKAGING CO., LTD., Yuyao City (CN)

(72) Inventors: Sen CHEN, Yuyao City (CN); Shunjin JI, Yuyao City (CN)

(73) Assignee: ZHEJIANG UKPACK PACKAGING CO., LTD., Yuyao City (CN)

(21) Appl. No.: 18/231,943

(22) Filed: Aug. 9, 2023

(30) Foreign Application Priority Data
Sep. 8, 2022 (CN) 202211097338.4
Feb. 21, 2023 (CN) 202310160405.0

(51) Int. Cl. B65D 45/16; A45D 33/00; B65D 1/02; B65D 51/24; B65D 53/02

(52) U.S. Cl. CPC B65D 45/16; A45D 33/00; B65D 1/023; B65D 51/245; B65D 53/02; B65D 2203/00

(57) ABSTRACT

A one-handed press-open cosmetic container includes a bottle body assembly and a cap assembly, and the cap assembly is fixed to the snap-fit groove of the bottle neck by the clasps of the claws in the cap assembly; wherein the cap assembly includes an outer and inner cap and claws, wherein the clasps are equally spaced and L-shaped, disposed down inwardly, and the ends are provided with inwardly humped heads, the clasps are respectively snapped into the clasp holes at the top corners of the inner cap, and securely snap-fit to the snap-fit groove through the clasp head, the top center of the resilient disc surface of the claws includes an upwardly humped button column, which extends from or is disposed in the center hole of the outer cap, when a force is applied, the claws drive the clasp head to open outwardly until it detaches from the snap ring.

### TECHNICAL FIELD

The present invention relates to caps of the containers intended for cosmetics (e.g.: creams), and is a one-handed press-open cosmetic container.

### BACKGROUND OF ART

Cosmetic containers mainly refer to containers intended for creams, lotions, perfumes and other cosmetic bottles, some of which are used for creams, face creams and other highly sealed viscous cosmetic containers. For example, cream jar is a kind of bottle used for storing moisturizing cream, the body and cap of such bottles are usually fabricated from plastic material and categorized as double-layer bottles and single-layer bottles depending on the body structure. Such cosmetic containers are usually opened by rotating or pressing the cap such that the cream stored in the bottle or flowing out of the inner cap can be dipped by finger; for example, Chinese patent document as disclosed in Application No. 201911051594.8, Application Publication Date: 21 Feb. 2020, Title of Patent: “An all-plastic vacuum cream bottle in simple structure”; for another example, Chinese patent document as disclosed in Application No. ZL200820164066.4, Application Publication Date: 8 Jul. 2009, Title of Utility Model: “A press-open cream bottle”. The caps of other like products can be opened by pressing the button of the opening sleeve on the inner cap, for example, Chinese patent document as disclosed in Application No. 201110432098.4, Application Publication Date: 13 Jun. 2012, Title of Patent: “A press-open bottle cap”; however, the caps of the above-mentioned products and like products can be categorized to a sort of anti-theft opening structure design. To be specific, these caps have to be pre-opened by rotating before use, then pressed to open, unfriendly to cap opening. The complicated structure design makes the height of the bottle cap assembly greater, resulting in inconvenient production and assembly, poorer integrity and stability.

### SUMMARY OF INVENTION

To overcome the above-mentioned deficiencies, the object of the present invention is to deliver a one-handed press-open cosmetic container for this technical field, to the extent that it can address the technical concerns of the existing similar products: inconvenience of use, poor experience, inaccessibility to produce and assemble, poor integrity and stability and in particular, the flawed design of the snap-fit structure, and the snap-fit structure rarely uses the plastic resilience and the leverage principle. This object is attained by the following technical solution.

A one-handed press-open cosmetic container comprises a bottle body assembly and a bottle cap assembly, the bottle body assembly is provided with humped snap ring at the outer diameter of the bottle neck at the bottle body, a snap-fit groove is provided at the outer diameter of the bottle neck underneath the snap ring, and the bottle cap assembly is fixed to the snap-fit groove of the bottle neck at the bottle body by a clasp of the claw in the bottle cap assembly; where the said bottle cap assembly comprises a outer cap, claws and an inner cap, and the clasps of the claws are equally spaced and appear as L-shaped, disposed down inwardly, and the ends of the clasps are provided with inwardly humped heads, the clasps of the claws are respectively snapped into the clasp holes at the top corners of the inner cap, and the clasps of the claws are snapped into the clasp holes of the inner cap and securely snap-fit to the snap-fit groove of the bottle neck at the bottle body through the clasp head on one end of the clasp; the top of the claw is provided with a resilient disc surface that is driven by pressing on top to deform the clasp and expand outwardly and detach from the snap-fit groove of the bottle neck at the said bottle body, the top center of the resilient disc surface of the claws is provided with an upwardly humped button column, the button column extends from or is disposed in the center hole of the top of the outer cap, and the inner cap with claws is snapped into the outer cap and the outer cap is engaged with the inner cap as one piece. To open the said bottle cap assembly, press on the claw in the bottle cap assembly, the clasp of the claw is deformed driving the clasp head on both ends to expand outwardly, the clasp head is readily detached from the snap ring of the bottle body, the bottle cap assembly is opened. This mode of cap opening leverages the linkage and resilience of the entire claw structure; the bottle cap assembly is opened for ease of use of cream. Now referring to the following structures, a scoop can be either disposed in the groove on top of the inner cap, or in the bottom storage groove at the bottle body of the bottle body assembly.

According to the characteristics of the above structure, a magnet can be disposed on the bottom of the groove of the inner cap, the bottom of the claw on top of the bottle body of the bottle body assembly is provided with an iron scoop, and the iron scoop is securely attached to the magnet inside the inner cap.

A metal spring is disposed inside the groove of the said inner cap which further stabilizes and boosts the elastic deformation and resilience of the claws.

The clasp of the said claw is provided with a curved humped inner rib respectively at the joint with the resilient disc surface, the button column, inner rib and clasp of the claw are molded in one piece, the inner rib of the claws is respectively abutted against the top outer end corner of the clasp hole of the inner cap, the curved corners of the inner cap are beveled upwardly and the outer side is a protrusion of the said curved corners, and the top rib in the outer cap is abutted against the top end corner at the inner rib of the claw. The above structure makes it convenient for the clasp of the claw to expand outwardly based on the leverage principle through the curved structure at the inner rib of the claw when applied a force, which further boosts the resilience property of the claw.

The clasps of the said claw are arranged symmetrically in six equally spaced pairs, the L-shaped clasps make the said resilient disc surface respectively with the annular rib joined at the inner rib and the other end of the clasp is engaged with the button column as one piece. An embodiment of the specific structure of the claw is described above, where the claws of the six snap-fit structures have better stability.

the outer resilient disc surface of the button column of the claw is provided with an annular groove, and the other end of the clasp is provided with a spacing groove at the annular groove where the button column is engaged with the button column as one piece. The said structure further boosts the linkage and resilience of the entire claw structure.

The top of the said inner cap is provided with a downwardly humped groove, the bottle body assembly is provided with a sealing washer above the bottle neck at the bottle body of the bottle body assembly, the groove of the inner cap is snapped into the center hole of the sealing washer, and the bottom of the resilient disc surface of the claw is disposed above the groove of the inner cap. The said structure facilitates the sealing between the sealing washer and the bottle body, the inner cap is engaged with the sealing washer as one piece and when opened, the bottle cap assembly is slightly popped upwards under the counteracting force of the sealing washer, which makes it convenient to remove the bottle cap assembly.

The button column of the said claw is a button snapped into the center of the resilient disc surface on top of the claw, with the button limit extending out or disposed in the center hole on top of the outer cap. An embodiment of the combination structure of the claw and the button is described above.

The top of the button column or the button of the said claw is provided with a mark, the button column or the button of the claw appears in round, polygonal, oval, star, heart or irregular shape. The said structure makes it convenient to mark the product and modify the shape.

The top of the said outer cap omits the central hole, the top of the button column of the claw is abutted against the top inside the outer cap, when a force is applied on top, the outer cap will transmit the force to the top of the claw, where the claw is forced to drive the deformation of the clasp, expand outwardly and detach from the snap-fit groove of the bottle neck at the said bottle body. An embodiment of the structure concealing the button column in the outer cap is described above, or alternatively, the button column of the outer cap can be omitted, it is enough to deform the claw in the outer cap as driven by the top of the outer cap when pressed.

The structure of the present invention is designed simple and reasonable, easy to assemble, produce and open and in particular, the bottle cap has better stability and integrity; it can be suitably used as one-handed press-open cosmetic container, as well as the modified structure of like products.

### BRIEF DESCRIPTION OF THE DRAWINGS

FIG. 1 is a schematic diagram of the exploded structure of the first embodiment of the present invention.

FIG. 2 is a schematic diagram of the cross-sectional structure in the initial state of FIG. 1.

FIG. 3 is a schematic diagram of the cross-sectional structure as opened of FIG. 2.

FIG. 4 is a schematic diagram of the modified cross-sectional structure as opened of FIG. 3.

FIG. 5 is a schematic diagram of the claw structure of FIG. 4.

FIG. 6 is a schematic diagram of the modified claw structure of FIG. 1.

FIG. 7 is a schematic diagram of the cross-sectional structure of the second embodiment of the present invention, with the box in the figure being a 3D view of an iron scoop.

FIG. 8 is a schematic diagram of the modified structure of FIG. 7.

The serial number and name of the accompanying drawings: 1. Outer cap, 101. Reinforcing rib, 2. Claw, 201. Button column, 202. Inner rib, 203. Clasp, 204. Annular groove, 3. Inner cap, 301. Clasp hole, 302. Groove, 4. Sealing washer, 5. Bottle body assembly, 501. Snap ring, 502. Snap-fit groove, 6. Button, 7. Magnet, 8. Iron scoop, 9. Metal spring.

### EMBODIMENTS

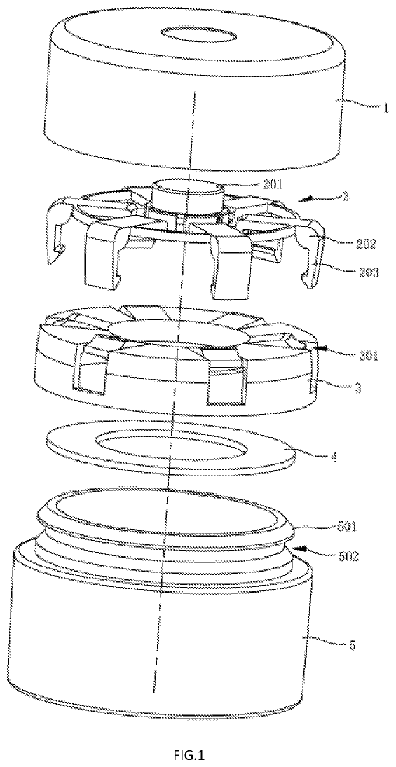

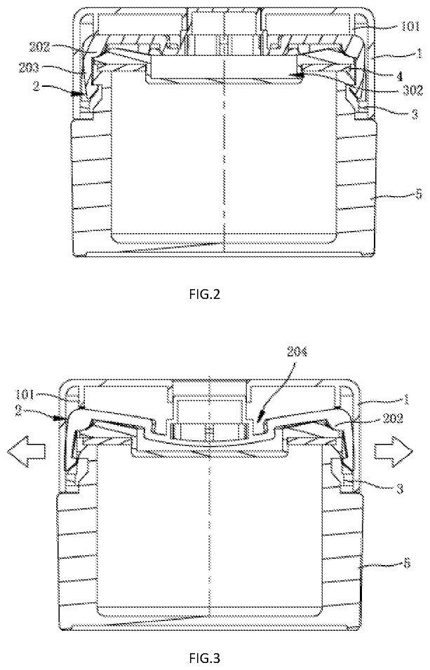

Now referring to the accompanying drawings, the structure and use of the present invention are further described. With respect to Embodiment 1 as referred to in FIGS. 1-3, a one-handed press-open cosmetic container comprises a bottle body assembly 5 and a bottle cap assembly, the bottle body assembly is provided with humped snap ring 501 at the outer diameter of the bottle neck at the bottle body, a snap-fit groove 502 is provided at the outer diameter of the bottle neck underneath the snap ring, and the bottle cap assembly is fixed to the snap-fit groove of the bottle neck at the bottle body by a clasp 203 of the claw in the bottle cap assembly; where the said bottle cap assembly comprises a outer cap 1, claws 2 and an inner cap 3, and the clasps 203 of the claws are equally spaced and appear as L-shaped, disposed down inwardly, and the ends of the clasps are provided with inwardly humped heads, the clasps of the claws are respectively snapped into the clasp holes 301 at the top corners of the inner cap, and the clasps of the claws are snapped into the clasp holes of the inner cap and securely snap-fit to the snap-fit groove 502 of the bottle neck at the bottle body through the clasp head on one end of the clasp; the top of the claw is provided with a resilient disc surface that is driven by pressing on top to deform the clasp and expand outwardly and detach from the snap-fit groove of the bottle neck at the said bottle body, the top center of the resilient disc surface of the claws is provided with an upwardly humped button column 201, the button column extends from or is disposed in the center hole of the top of the outer cap, and the inner cap with claws is snapped into the outer cap and the outer cap is engaged with the inner cap as one piece.

The particular structure of the said inner cap and claw is described as follows: the clasp of the said claw is provided with a curved humped inner rib 202 respectively at the joint with the resilient disc surface, the button column, inner rib and clasp of the claw are molded in one piece, the inner rib of the claws is respectively abutted against the top outer end corner of the clasp hole of the inner cap, the curved corners of the inner cap are beveled upwardly and the outer side is a protrusion of the said curved corners, and the top reinforcing rib 101 in the outer cap is abutted against the top end corner at the inner rib of the claw. The clasps of the said claw are arranged symmetrically in six equally spaced pairs, the L-shaped clasps make the said resilient disc surface respectively with the annular rib joined at the inner rib and the other end of the clasp is engaged with the button column as one piece. The outer resilient disc surface of the button column of the claw is provided with an annular groove 204, and the other end of the clasp is provided with a spacing groove at the annular groove where the button column is engaged with the button column as one piece. The top of the inner cap is provided with a downwardly humped groove 302, the bottle body assembly is provided with a sealing washer 4 above the bottle neck at the bottle body of the bottle body assembly, the groove of the inner cap is snapped into the center hole of the sealing washer, and the bottom of the resilient disc surface of the claw is disposed above the groove of the inner cap.

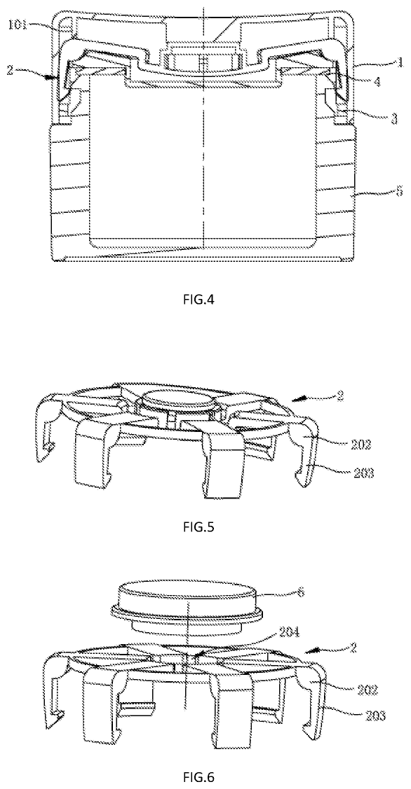

As referred to in FIGS. 4 and 5, the top of the outer cap omits the central hole, the top of the button column of the claw is abutted against the top inside the outer cap, when a force is applied on top, the outer cap will transmit the force to the top of the claw, where the claw is forced to drive the deformation of the clasp, expand outwardly and detach from the snap-fit groove of the bottle neck at the said bottle body. As referred to in FIG. 6, the button column of the said claw is a button 6 snapped into the center of the resilient disc surface on top of the claw, with the button limit extending out or disposed in the center hole on top of the outer cap.

Press the button column of the claw by the outer cap, as contained by the reinforcing rib of outer cap and the clasp hole of the inner cap, the claw will rotate by the center of the inner rib based on the leverage principle, the vertical movement of the clasp at the button column will be turned to the horizontal movement of the clasp at the clasp. At this point, the clasp of the claw is detached from the bottle body assembly such that the cap is opened. Once opened, the bottle cap assembly is slightly popped upwards under the counteracting force of the sealing washer, which makes it more convenient to remove the bottle cap assembly.

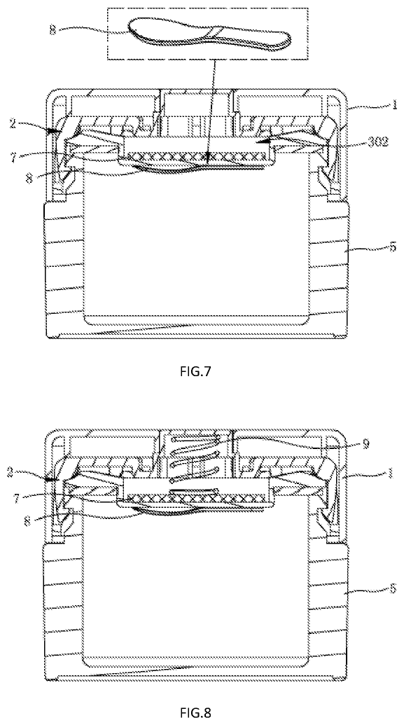

According to the above structural characteristics of Embodiment 1 and based on Embodiment 1, as referred to Embodiment 2 of FIGS. 7 and 8, a magnet 7 is disposed on the bottom of the groove of the said inner cap, an iron scoop 8 is disposed on the bottom of the claw on top of the bottle body of the bottle body assembly, and the iron scoop is securely attached to the magnet inside the inner cap. A metal spring 9 is disposed inside the groove of the said inner cap which further boosts the resilience property of the claws.

To sum up, the cosmetic container can be opened by pressing the cap with one hand which eliminates the need of rotating or two-handed operation when opening or closing cap of the existing bottles available on the market, and enhances the perceived experience and convenient. It is operated on the principle of resilience and leverage of plastic parts. The snap-fit structure of the claw and the pressing operation structure from the top are considered as the primary technical characteristics of the cosmetic container, a LOGO is tailored for the area to press claw at the customer request, and this area may appear in round, polygonal, oval, star, heart or irregular shape.

1. A one-handed press-open cosmetic container comprises a bottle body assembly and a bottle cap assembly, the bottle body assembly is provided with humped snap ring at the outer diameter of the bottle neck at the bottle body, a snap-fit groove is provided at the outer diameter of the bottle neck underneath the snap ring, and the bottle cap assembly is fixed to the snap-fit groove of the bottle neck at the bottle body by a clasp of the claw in the bottle cap assembly; where the bottle cap assembly comprises a outer cap, claws and an inner cap, and the clasps of the claws are equally spaced and appear as L-shaped, disposed down inwardly, and the ends of the clasps are provided with inwardly humped heads, the clasps of the claws are respectively snapped into the clasp holes at the top corners of the inner cap, and the clasps of the claws are snapped into the clasp holes of the inner cap and securely snap-fit to the snap-fit groove of the bottle neck at the bottle body through the clasp head on one end of the clasp; the top of the claw is provided with a resilient disc surface that is driven by pressing on top to deform the clasp and expand outwardly and detach from the snap-fit groove of the bottle neck at the bottle body, the top center of the resilient disc surface of the claws is provided with an upwardly humped button column, the button column extends from or is disposed in the center hole of the top of the outer cap, and the inner cap with claws is snapped into the outer cap and the outer cap is engaged with the inner cap as one piece.

2. A one-handed press-open cosmetic container according to claim 1, where the clasp of the claw is provided with a curved humped inner rib respectively at the joint with the resilient disc surface, the button column, inner rib and clasp of the claw are molded in one piece, the inner rib of the claws is respectively abutted against the top outer end corner of the clasp hole of the inner cap, the curved corners of the inner cap are beveled upwardly and the outer side is a protrusion of the curved corners, and the top reinforcing rib in the outer cap is abutted against the top end corner at the inner rib of the claw.

3. A one-handed press-open cosmetic container according to claim 2, wherein the clasps of the claw are arranged symmetrically in six equally spaced pairs, the L-shaped clasps make the resilient disc surface respectively with the annular rib joined at the inner rib and the other end of the clasp is engaged with the button column as one piece.

4. A one-handed press-open cosmetic container according to claim 3, wherein the outer resilient disc surface of the button column of the claw is provided with an annular groove, and the other end of the clasp is provided with a spacing groove at the annular groove where the button column is engaged with the button column as one piece.

5. A one-handed press-open cosmetic container according to claim 1, wherein the top of the inner cap is provided with a downwardly humped groove, the bottle body assembly is provided with a sealing washer above the bottle neck at the bottle body of the bottle body assembly, the groove of the inner cap is snapped into the center hole of the sealing washer, and the bottom of the resilient disc surface of the claw is disposed above the groove of the inner cap.

6. A one-handed press-open cosmetic container according to claim 5, wherein the bottom of the groove of the inner cap is provided with a magnet, the bottom of the claw on top of the bottle body of the bottle body assembly is provided with an iron scoop, and the iron scoop is securely attached to the magnet inside the inner cap.

7. A one-handed press-open cosmetic container according to claim 5, wherein the groove of the inner cap is provided with a metal spring.

8. A one-handed press-open cosmetic container according to claim 1, wherein the button column of the claw is a button snapped into the center of the resilient disc surface on top of the claw, with the button limit extending out or disposed in the center hole on top of the outer cap.

9. A one-handed press-open cosmetic container according to claim 8, wherein the top of the button column or the button of the claw is provided with a mark, the button column or the button of the claw appears in round, polygonal, oval, star, heart or irregular shape.

10. A one-handed press-open cosmetic container according to claim 1, the top of the outer cap omits the central hole, the top of the button column of the claw is abutted against the top inside the outer cap, when a force is applied on top, the outer cap will transmit the force to the top of the claw, where the claw is forced to drive the deformation of the clasp, expand outwardly and detach from the snap-fit groove of the bottle neck at the bottle body.

11. A one-handed press-open cosmetic container according to claim 6, wherein the groove of the inner cap is provided with a metal spring.
